(19) United States
(12) Patent Application Publication
(10) Pub. No.: US 2019/0242582 A1
(43) Pub. Date: Aug. 8, 2019

(54) Thermal Attenuation Structure For Detonation Combustion System

(71) Applicant: General Electric Company, Schenectady, NY (US)

(72) Inventors: Arthur Wesley Johnson, Cincinnati, OH (US); Steven Clayton Vise, Loveland, OH (US); Clayton Stuart Cooper, Loveland, OH (US); Joseph Zelina, Waynesville, OH (US); Sibtosh Pal, Mason, OH (US)

(21) Appl. No.: 15/890,637

(22) Filed: Feb. 7, 2018

(51) Int. Cl. F23R 3/56; F02C 3/04; F23R 3/28

(52) U.S. Cl. CPC F23R 3/56; F23R 3/04; F23R 3/286; F02C 3/04

(57) ABSTRACT

A rotating detonation combustion (RDC) system including a detonation chamber wall extended along a longitudinal direction. The detonation chamber wall defines a detonation chamber radially in between the detonation chamber walls. The RDC system further includes a fuel-oxidizer nozzle defining a first convergent-divergent nozzle disposed upstream of the detonation chamber, and a gas nozzle defining a second convergent-divergent nozzle extended through the detonation chamber wall at least partially along the longitudinal direction. The gas nozzle provides a flow of gas into the detonation chamber at least partially co-directional to the detonation chamber wall.

### FIELD

The present subject matter is related to continuous detonation systems for heat engines.

### BACKGROUND

Many propulsion systems, such as gas turbine engines, are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such propulsion systems generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in either a continuous or pulsed mode. The pulsed mode design involves one or more detonation tubes, whereas the continuous mode is based on a geometry, typically an annulus, within which single or multiple detonation waves spin. For both types of modes, high energy ignition detonates a fuel/air mixture that transitions into a detonation wave (i.e., a fast moving shock wave closely coupled to the reaction zone). The detonation wave travels in a Mach number range greater than the speed of sound (e.g., Mach 4 to 8) with respect to the speed of sound of the reactants. The products of combustion follow the detonation wave at the speed of sound relative to the detonation wave and at significantly elevated pressure. Such combustion products may then exit through a nozzle to produce thrust or rotate a turbine.

Although detonation combustors may generally provide improved efficiency and performance over deflagrative combustion systems, the higher heat flux and pressure gain of detonation combustors currently defines detonation combustors as defining lower durability in contrast to conventional deflagrative combustors. Known cooling structures utilized for deflagrative combustors therefore do not address issues resulting from the higher heat flux or pressure gain of detonation combustors. As a result, integration of detonation combustors into aerospace, aeronautical, or power generating heat engines is limited due to their relatively low durability.

As such, there is a need for detonation combustion systems including structures that address limitations due to detonative combustion such as to improve the durability of detonation combustion systems.

### BRIEF DESCRIPTION

Aspects and advantages of the invention will be set forth in part in the following description, or may be obvious from the description, or may be learned through practice of the invention.

Aspects of the present disclosure are directed to a heat engine including a rotating detonation combustion (RDC) system. The RDC system includes a detonation chamber wall extended along a longitudinal direction, wherein the detonation chamber wall defines a detonation chamber radially inward thereof; a fuel-oxidizer nozzle defining a first convergent-divergent nozzle disposed upstream of the detonation chamber; and a gas nozzle defining a second convergent-divergent nozzle extended through the detonation chamber wall at least partially along the longitudinal direction. The gas nozzle provides a flow of gas into the detonation chamber at least partially co-directional to the detonation chamber wall.

In one embodiment, the gas nozzle is disposed between the fuel-oxidizer nozzle and the detonation chamber wall. The gas nozzle is disposed upstream of the detonation chamber.

In another embodiment, the gas nozzle is defined through the detonation chamber wall at least partially along a radial direction relative to a combustion centerline.

In various embodiments, the RDC system includes a plurality of gas nozzle extended through the detonation chamber wall at least partially along a radial direction relative to a combustion centerline. The plurality of gas nozzle is disposed in an adjacent circumferential arrangement through the detonation chamber wall relative to the combustion centerline. In one embodiment, the plurality of gas nozzles are further disposed in an adjacent arrangement along the longitudinal direction through the detonation chamber wall. In another embodiment, each longitudinal position of the plurality of gas nozzle defines an increasing pressure ratio along a downstream direction from the fuel-oxidizer nozzle. The pressure ratio is relative to a pressure plenum and the detonation chamber.

In still various embodiments, the gas nozzle is disposed at an acute angle through the detonation chamber wall. In one embodiment, the detonation chamber wall defines a longitudinally extended portion within the detonation chamber. The longitudinally extended portion is extended downstream of the gas nozzle to direct the flow of gas at least partially co-directional to the detonation chamber wall.

In one embodiment, the gas nozzle is defined annularly around the combustion centerline.

In another embodiment, the RDC system includes a plurality of the gas nozzle disposed in an adjacent arrangement around a circumferential direction around the combustion centerline.

In various embodiments, the heat engine further includes an inlet section through which a flow of oxidizer enters the heat engine. In still various embodiments, the heat engine further includes an expansion section through which a flow of combustion products exits the heat engine. In still yet various embodiments, the RDC system is disposed in serial arrangement between the inlet section and the expansion section.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic embodiment of a heat engine including a rotation detonation combustion (RDC) system according to an aspect of the present disclosure;

FIGS. 2-3 are cross sectional views of exemplary embodiments of the RDC system of FIG. 1;

FIG. 4 is a detailed view of a portion of the RDC system of FIG. 3;

FIGS. 5-7 are cross sectional views of exemplary embodiments of the RDC system generally provided in FIGS. 2-4; and

FIG. 8 is an exemplary embodiment of a detonation chamber of a rotating detonation combustion system generally in accordance with an embodiment of the present disclosure generally provided in FIGS. 1-7.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “forward” and “aft” refer to relative positions within a heat engine or vehicle, and refer to the normal operational attitude of the heat engine or vehicle. For example, with regard to a heat engine, forward refers to a position closer to a heat engine inlet and aft refers to a position closer to a heat engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Embodiments of a heat engine 10 including a rotating detonation combustion (RDC) system are generally provided. The embodiments shown and described herein provide structures that improve durability of the RDC system such as via a thermal attenuation structure. The embodiments of the RDC system described herein include a convergent-divergent gas nozzle that provides film cooling to a detonation chamber wall to attenuate adverse effects of a higher heat flux and increasing pressure gradient resulting from detonative combustion in contrast to deflagrative combustion. As such, embodiments of the RDC system generally shown and described herein may improve RDC system durability that may further enable integration of RDC systems into heat engines commercial, industrial, or military apparatuses requiring durability generally provided with deflagrative combustion systems.

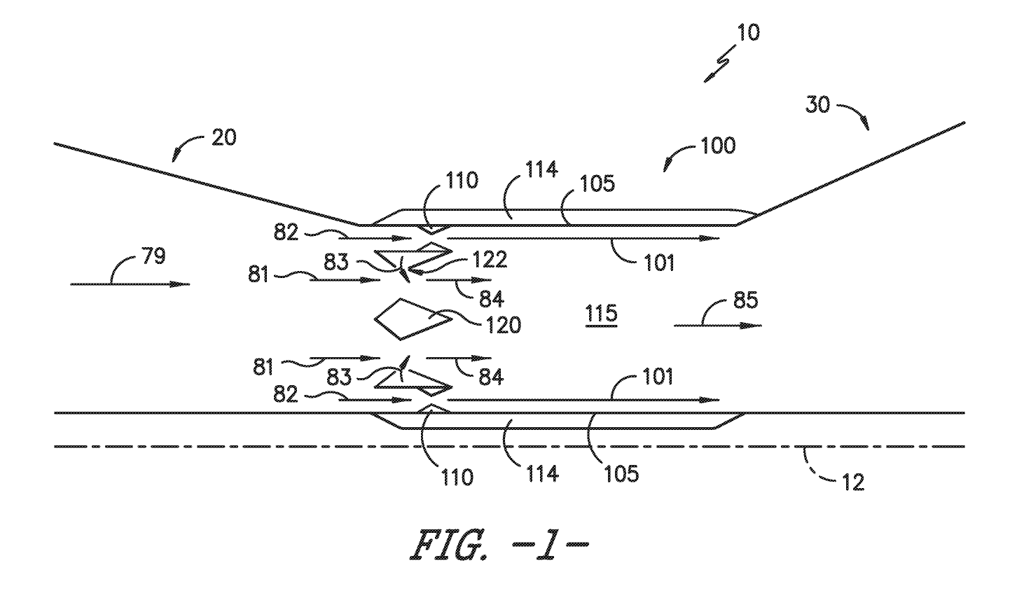

Referring now to the figures, FIG. 1 depicts a heat engine 10 including a rotating detonation combustion system 100 (an “RDC system”) in accordance with an exemplary embodiment of the present disclosure. The heat engine 10 generally includes an inlet section 20 and an expansion section 30. In one embodiment, the RDC system 100 is located downstream of the inlet section 20 and upstream of the expansion section 30, such as in serial arrangement therebetween. In various embodiments, the heat engine 10 defines a gas turbine engine, a ramjet, or other heat engine including a fuel-oxidizer burner producing combustion products that provide propulsive thrust or mechanical energy output. In an embodiment of the heat engine 10 defining a gas turbine engine, the inlet section 20 includes a compressor section defining one or more compressors generating a flow of oxidizer 79 to the RDC system 100. The inlet section 20 may generally guide a flow of the oxidizer 79 to the RDC system 100. The inlet section 20 may further compress the oxidizer 79 before it enters the RDC system 100. The inlet section 20 defining a compressor section may include one or more alternating stages of rotating compressor airfoils. In other embodiments, the inlet section 20 may generally define a decreasing cross sectional area from an upstream end to a downstream end proximate to the RDC system 100.

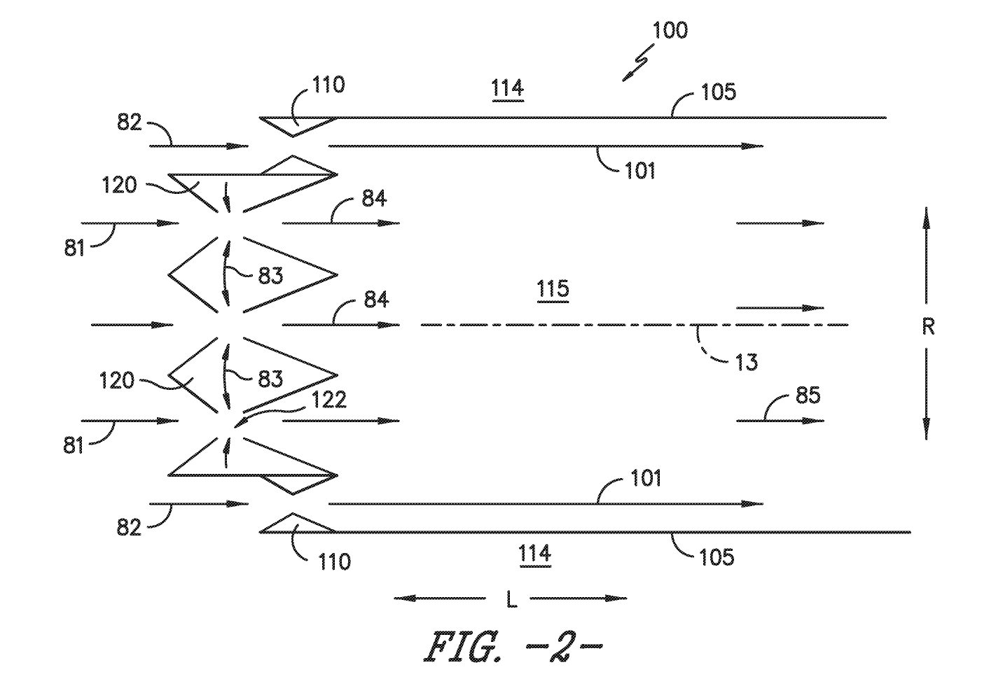

As will be discussed in further detail below, at least a portion of the flow of oxidizer 79 is mixed with a liquid or gaseous fuel 83 (or combinations thereof, or combinations of liquid fuel with a gas) and detonated to generate combustion products 85 (FIG. 2). The combustion products 85 flow downstream to the expansion section 30. In various embodiments, the expansion section 30 may generally define an increasing cross sectional area from an upstream end proximate to the RDC system 100 to a downstream end of the heat engine 10. Expansion of the combustion products 85 generally provides thrust that propels the apparatus to which the heat engine 10 is attached, or provides mechanical energy to one or more turbines further coupled to a fan section, a generator or other electric machine, or both. Thus, the expansion section 30 may further define a turbine section of a gas turbine engine including one or more alternating rows or stages of rotating turbine airfoils. The combustion products 85 may flow from the expansion section 30 through, e.g., an exhaust nozzle to generate thrust for the heat engine 10.

As will be appreciated, in various embodiments of the heat engine 10 defining a gas turbine engine, rotation of the turbine(s) within the expansion section 30 generated by the combustion products 85 is transferred through one or more shafts or spools to drive the compressor(s) within the inlet section 20. In various embodiments, the inlet section 20 may further define a fan section, such as for a turbofan engine configuration, such as to propel air across a bypass flowpath outside of the RDC system 100 and expansion section 30.

It will be appreciated that the heat engine 10 depicted schematically in FIG. 1 is provided by way of example only. In certain exemplary embodiments, the heat engine 10 may include any suitable number of compressors within the inlet section 20, any suitable number of turbines within the expansion section 30, and further may include any number of shafts or spools appropriate for mechanically linking the compressor(s), turbine(s), and/or fans. Similarly, in other exemplary embodiments, the heat engine 10 may include any suitable fan section, with a fan thereof being driven by the expansion section 30 in any suitable manner. For example, in certain embodiments, the fan may be directly linked to a turbine within the expansion section 30, or alternatively, may be driven by a turbine within the expansion section 30 across a reduction gearbox. Additionally, the fan may be a variable pitch fan, a fixed pitch fan, a ducted fan (i.e., the heat engine 10 may include an outer nacelle surrounding the fan section), an un-ducted fan, or may have any other suitable configuration.

Moreover, it should also be appreciated that the RDC system 100 may further be incorporated into any other suitable aeronautical heat engine, such as a turboshaft engine, a turboprop engine, a turbojet engine, a ramjet engine, a scramjet engine, etc. Further, in certain embodiments, the RDC system 100 may be incorporated into a non-aeronautical heat engine, such as a land-based or marine-based power generation system. Further still, in certain embodiments, the RDC system 100 may be incorporated into any other suitable heat engine, such as a rocket or missile engine. With one or more of the latter embodiments, the heat engine may not include a compressor in the inlet section 20 or a turbine in the expansion section 30.

Referring now to FIGS. 2-4, exemplary embodiments of the RDC system 100 of the engine 10 of FIG. 1 are generally provided. The RDC system 100 includes a detonation chamber wall 105 extended along the longitudinal direction L. The detonation chamber wall 105 defines a detonation chamber 115 radially inward of the detonation chamber wall 105. The RDC system 100 further includes a fuel-oxidizer nozzle 120 defining a first convergent-divergent nozzle disposed upstream of the detonation chamber 115. A flow of oxidizer from the inlet section, shown schematically by arrows 81, passes though the fuel-oxidizer nozzle 120. A fuel injection opening 122 is defined through the fuel-oxidizer nozzle 120 to provide a flow of liquid or gaseous fuel (or combinations thereof), shown schematically by arrows 83, to mix with the flow of oxidizer 81 to produce a fuel-oxidizer mixture, shown schematically by arrows 84, at the detonation chamber 115. The fuel-oxidizer mixture 84 is then detonated in the detonation chamber 115 such as further described below.

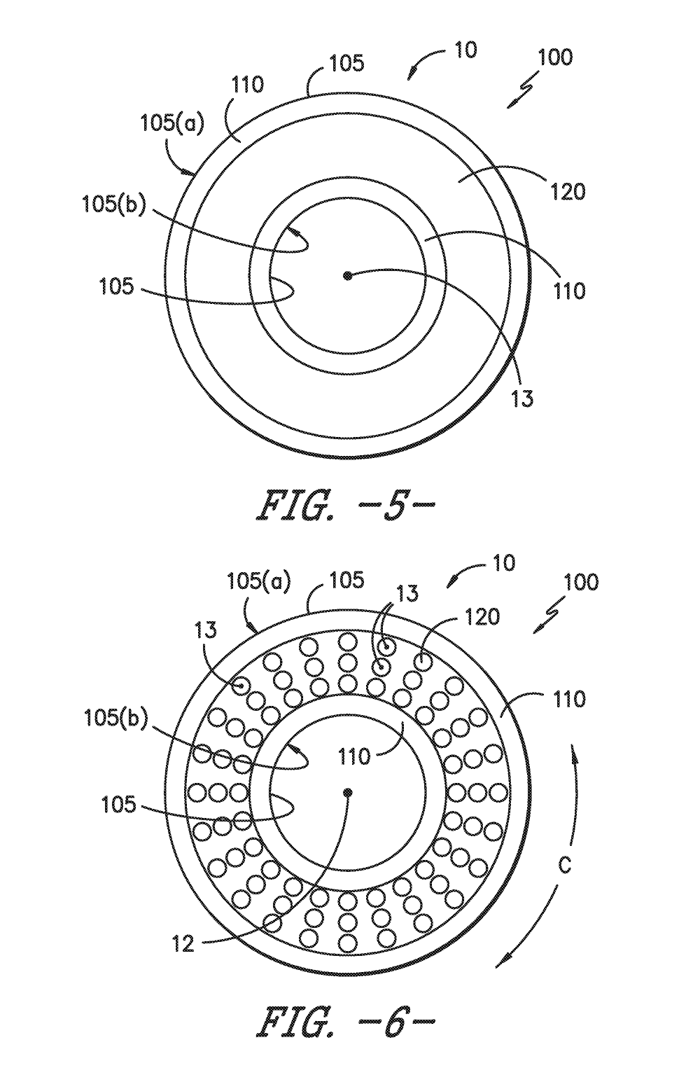

In various embodiments, such as generally depicted in FIGS. 5-7, the detonation chamber wall 105 further defines an outer detonation chamber wall 105(a) radially outward of the fuel oxidizer nozzle 120 and an inner detonation chamber wall 105(b) radially inward of the fuel oxidizer nozzle 120. Each wall 105(a), 105(b) is disposed in substantially concentric arrangement to one another. In various embodiments, the walls 105(a), 105(b) are defined generally concentric around the combustion centerline 13. The gas nozzle 110 is defined adjacent to the detonation chamber wall 105. For example, the gas nozzle 110 is defined adjacent to the outer and inner detonation chamber walls 105(a), 105(b). As another example, the gas nozzle 110 is defined radially outward and/or inward of the fuel-oxidizer nozzle 120. Still further, the gas nozzle 110 may be defined generally radially between the detonation chamber wall 105 and the fuel-oxidizer nozzle 120.

Referring briefly to FIG. 8, providing a perspective view of the detonation chamber 115 (without the fuel-oxizider nozzle 120), it will be appreciated that the RDC system 100 generates a detonation wave 230 during operation. The detonation wave 230 travels in a circumferential direction C of the RDC system 100 consuming an incoming fuel/oxidizer mixture 84 and providing a high pressure region 234 within an expansion region 236 of the combustion. A burned fuel/oxidizer mixture 85 (i.e., combustion products) exits the detonation chamber 115 and is exhausted.

More particularly, it will be appreciated that the RDC system 100 is of a detonation-type combustor, deriving energy from the continuous detonation wave 230. For a detonation combustor, such as the RDC system 100 disclosed herein, the combustion of the fuel/oxidizer mixture 84 is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh fuel-oxidizer mixture 84, increasing such fuel-oxidizer mixture 84 above a self-ignition point. On the other side, energy released by the combustion contributes to the propagation of the detonation shockwave 230. Further, with continuous detonation, the detonation wave 230 propagates around the combustion chamber 115 in a continuous manner, operating at a relatively high frequency. Additionally, the detonation wave 230 may be such that an average pressure inside the combustion chamber 115 is higher than an average pressure within typical combustion systems (i.e., deflagration combustion systems). Accordingly, the region 234 behind the detonation wave 230 has very high pressures.

Referring back to FIGS. 2-4, the RDC system 100 further includes a gas nozzle 110 defining a second convergent-divergent nozzle extended through the detonation chamber wall 105 at least partially along the longitudinal direction L. The gas nozzle 110 provides a flow of gas, shown schematically by arrows 82, into the detonation chamber 115 at least partially co-directional to the detonation chamber wall 105, such as shown schematically by arrows 101. In various embodiments, the gas nozzle 110 is disposed radially outward of the fuel-oxidizer nozzle 120 along a combustion centerline 13 extended through the RDC system 100. In the various embodiments, the gas nozzle 110 is disposed upstream of the detonation chamber 115. In still various embodiments, the gas nozzle 110 is disposed inward and/or outward of the fuel-oxidizer nozzle 120, such as more radially proximate to the detonation chamber wall 105 relative to the fuel-oxidizer nozzle 120.

The gas nozzle 110 provides the flow of gas 82 alongside or through the detonation chamber wall 105 to provide thermal attenuation (e.g., cooling) at the detonation chamber wall 105 to mitigate deleterious effects of the high heat and pressure generated during detonation of the fuel-oxidizer mixture 84. The flow of gas 82 entering the convergent-divergent structure of the gas nozzle 110 provides a wall of film cooling 101 adjacent to the detonation chamber wall 105. The convergent-divergent gas nozzle 110 further defines a throat 109 to minimize flow from downstream to upstream during each cycle of detonation in the detonation chamber 115. As such, the gas nozzle 110 provides a stream of film cooling 101 adjacent along the length of the detonation chamber wall 105, providing a buffer from the combustion products 85, or from the combustion products 85 defined by the detonation wave 230 (FIG. 8).

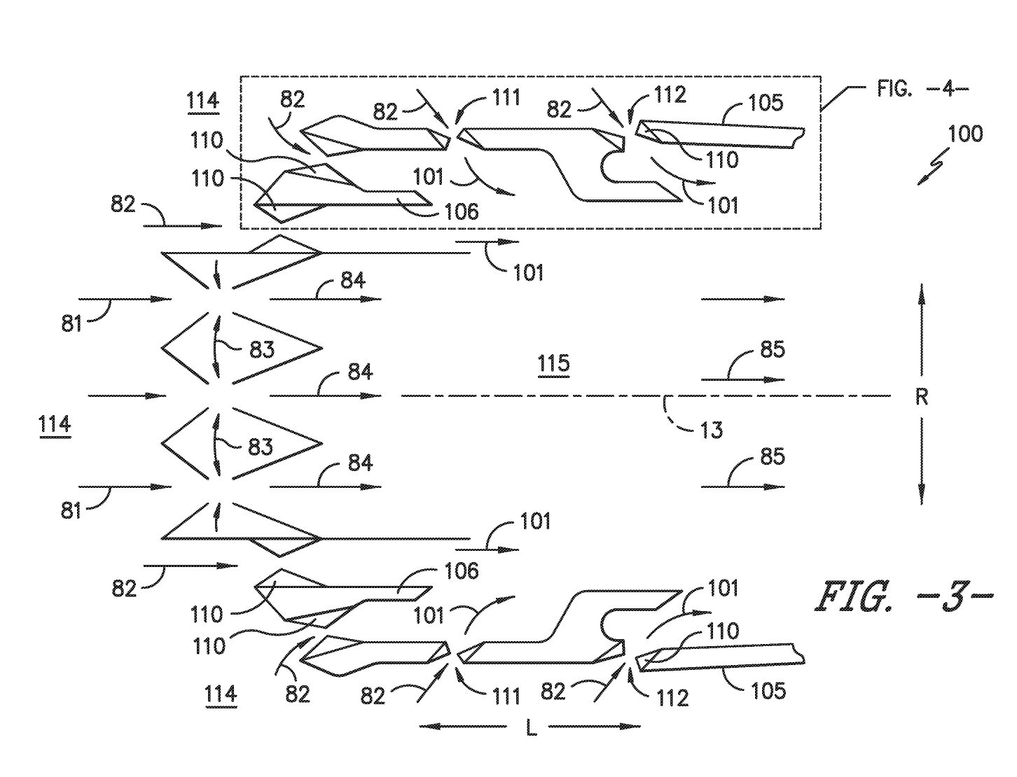

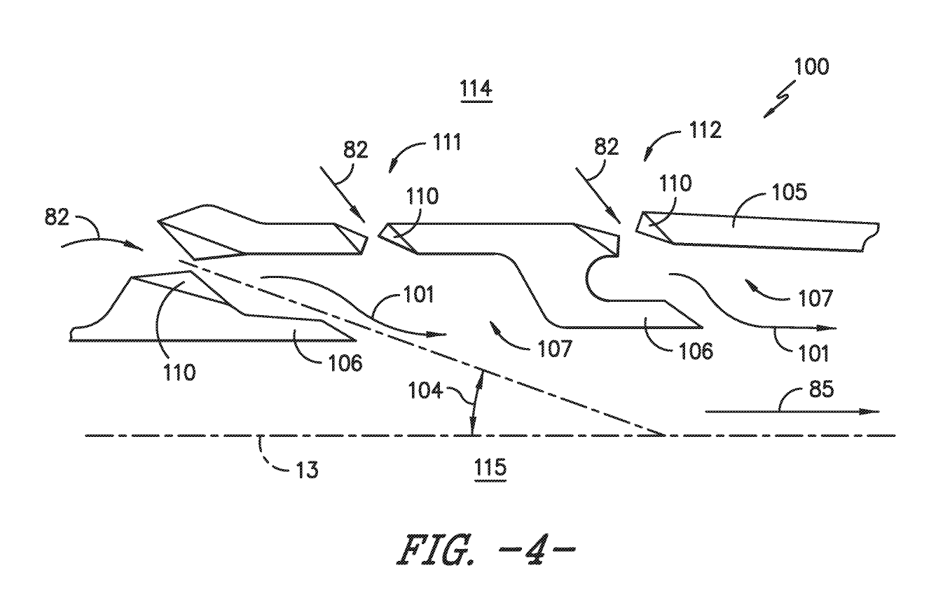

Referring now to the embodiments generally provided in FIGS. 3-4, the gas nozzle 110 may further be defined through the detonation chamber wall 105 at least partially along a radial direction R relative to a combustion centerline 13. For example, the gas nozzle 110 may be defined such as to dispose the flow of film cooling 101 at least partially inward toward the detonation chamber 115. As such, in various embodiments, the gas nozzle 110 may be disposed at an acute angle 104 through the detonation chamber wall 105, such as generally depicted in further detail in regard to FIG. 4.

Referring still to the detailed view of a portion of the RDC system 100 generally provided in FIG. 4, the detonation chamber wall 105 may further define a longitudinally extended portion 106 extended partially within the detonation chamber 115. The longitudinally extended portion 106 is extended downstream of the gas nozzle 110 to direct the egressing flow of film cooling 101 at least partially co-directional to the detonation chamber wall 105. In various examples, the longitudinally extended portion 106 is extended radially from the gas nozzle 110 and further along the longitudinal direction such that the detonation chamber wall 105 defines a groove or cavity 107. In various embodiments, the groove or cavity 107 may be extended annularly through the detonation chamber wall 105. In other embodiments, each groove or cavity 107 may define a depression or dimple defining the gas nozzle 110 as its center.

Referring still to FIG. 4, the RDC system 100 may define a plurality of gas nozzle 110 extended through the detonation chamber wall 105 each disposed in an adjacent circumferential arrangement through the detonation chamber wall 105 relative to the combustion centerline 13. In various embodiments, the plurality of gas nozzle 110 are further disposed in an adjacent arrangement along the longitudinal direction L through the detonation chamber wall 105. For example, the plurality of gas nozzles 110 may define a first gas nozzle 111 generally forward along the longitudinal direction L, a second gas nozzle 112 aft along the longitudinal direction of the first gas nozzle 111, and etc. to an Nth gas nozzle at an aft-most or downstream end of the detonation chamber 115. Each of the plurality of gas nozzles 110 along the longitudinal direction may define a convergent-divergent nozzle based on an expected pressure increase within the detonation chamber 115 relative to a position along the longitudinal direction L. For example, each longitudinal position of the plurality of gas nozzle 110 (e.g., gas nozzle 111, gas nozzle 112, etc.) defines an increasing pressure ratio along a downstream direction (e.g., higher at gas nozzle 112 relative to gas nozzle 111) from the fuel-oxidizer nozzle 120. The pressure ratio is relative to a pressure plenum 114 and the detonation chamber 115. As such, the varying geometries or pressure ratios across each of the plurality of gas nozzles 110 provides the flow of film cooling 101 into the detonation chamber 115 and mitigates back flow of combustion products 85 through the gas nozzle 110 into the pressure plenum 114.

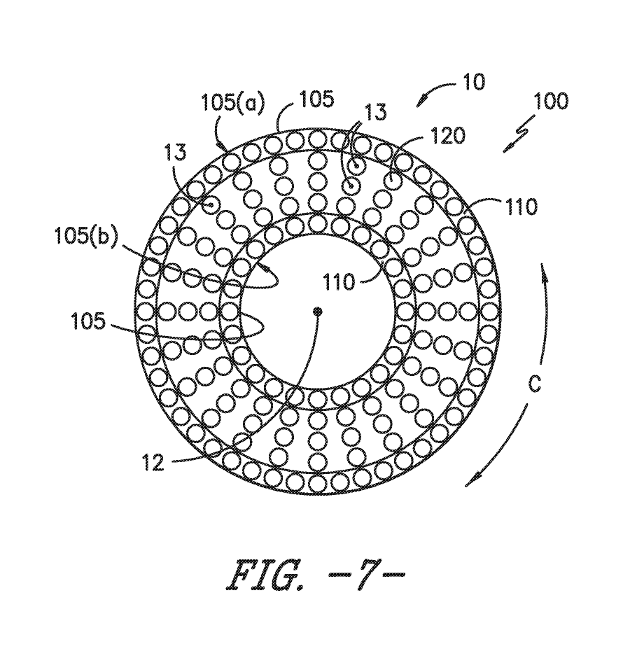

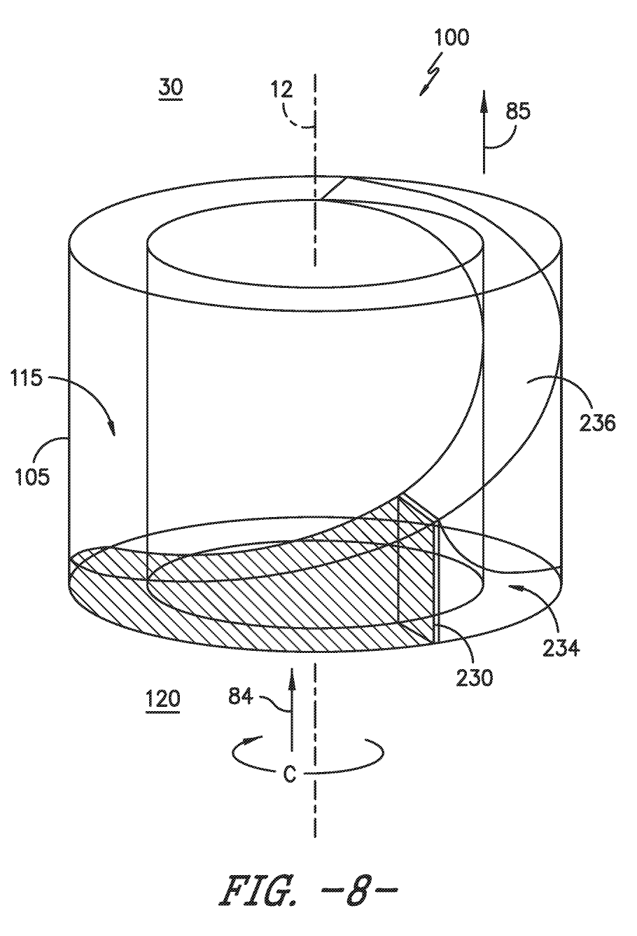

Referring now to FIGS. 5-7, cross sectional views of exemplary embodiments of the RDC system 100 are generally provided. The views generally provided in FIGS. 5-7 depict various embodiments of arrangement of the plurality of fuel-oxidizer nozzle 120 and gas nozzle 110 in the RDC system 100. In one embodiment, the detonation chamber wall 105 (including outer and inner detonation chamber walls 105(a), 105(b)), the gas nozzle 110, and the fuel-oxidizer nozzle 120 may each be defined annularly around the combustion centerline 13, such as shown and described in regard to FIG. 5. In another embodiment, the detonation chamber wall 105 may be defined annularly around the engine centerline 12 and the fuel-oxidizer nozzle 120 may be disposed in adjacent circumferential arrangement around the engine centerline 12 or combustion centerline 13 such as to define multiple individual nozzles 120 such as shown in regard to FIG. 6. In still another embodiment, a plurality of the gas nozzle 110 may define multiple individual nozzles 110, such as shown in regard to FIG. 7.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotating detonation combustion (RDC) system, the RDC system comprising:
a detonation chamber wall extended along a longitudinal direction, wherein the detonation chamber wall defines a detonation chamber radially inward thereof;
a fuel-oxidizer nozzle defining a first convergent-divergent nozzle disposed upstream of the detonation chamber; and
a gas nozzle defining a second convergent-divergent nozzle extended through the detonation chamber wall at least partially along the longitudinal direction, wherein the gas nozzle provides a flow of gas into the detonation chamber at least partially co-directional to the detonation chamber wall.

2. The RDC system of claim 1, wherein the gas nozzle is disposed between the fuel-oxidizer nozzle and the detonation chamber wall, and wherein the gas nozzle is disposed upstream of the detonation chamber.

3. The RDC system of claim 1, wherein the gas nozzle is defined through the detonation chamber wall at least partially along a radial direction relative to a combustion centerline.

4. The RDC system of claim 1, wherein the RDC system comprises a plurality of gas nozzle extended through the detonation chamber wall at least partially along a radial direction relative to a combustion centerline, wherein the plurality of gas nozzle are disposed in an adjacent circumferential arrangement through the detonation chamber wall relative to the combustion centerline.

5. The RDC system of claim 4, wherein the plurality of gas nozzle are further disposed in an adjacent arrangement along the longitudinal direction through the detonation chamber wall.

6. The RDC system of claim 5, wherein each longitudinal position of the plurality of gas nozzle defines an increasing pressure ratio along a downstream direction from the fuel-oxidizer nozzle, wherein the pressure ratio is relative to a pressure plenum and the detonation chamber.

7. The RDC system of claim 1, wherein the gas nozzle is disposed at an acute angle through the detonation chamber wall.

8. The RDC system of claim 7, wherein the detonation chamber wall defines a longitudinally extended portion within the detonation chamber, wherein the longitudinally extended portion is extended downstream of the gas nozzle to direct the flow of gas at least partially co-directional to the detonation chamber wall.

9. The RDC system of claim 1, wherein the gas nozzle is defined annularly around the combustion centerline.

10. The RDC system of claim 1, wherein the RDC system comprises a plurality of the gas nozzle disposed in an adjacent arrangement around a circumferential direction around the combustion centerline.

11. A heat engine, comprising:
an inlet section through which a flow of oxidizer enters the heat engine;
an expansion section through which a flow of combustion products exits the heat engine; and
a rotating detonation combustion system disposed in serial arrangement between the inlet section and the expansion section, the RDC system comprising:
a detonation chamber wall extended along a longitudinal direction, wherein the detonation chamber wall defines a detonation chamber radially inward thereof;
a fuel-oxidizer nozzle defining a first convergent-divergent nozzle disposed upstream of the detonation chamber; and
a gas nozzle defining a second convergent-divergent nozzle extended through the detonation chamber wall at least partially along the longitudinal direction, wherein the gas nozzle provides a flow of gas into the detonation chamber at least partially co-directional to the detonation chamber wall.

12. The heat engine of claim 11, wherein the gas nozzle of the RDC system is disposed radially between the fuel-oxidizer nozzle and the detonation chamber wall, and wherein the gas nozzle is disposed upstream of the detonation chamber.

13. The heat engine of claim 11, wherein the gas nozzle of the RDC system is defined through the detonation chamber wall at least partially along a radial direction relative to a combustion centerline.

14. The heat engine of claim 11, wherein the RDC system comprises a plurality of gas nozzle extended through the detonation chamber wall at least partially along a radial direction relative to a combustion centerline, wherein the plurality of gas nozzle are disposed in an adjacent circumferential arrangement through the detonation chamber wall relative to the combustion centerline.

15. The heat engine of claim 14, wherein the plurality of gas nozzle are further disposed in an adjacent arrangement along the longitudinal direction through the detonation chamber wall.

16. The heat engine of claim 15, wherein each longitudinal position of the plurality of gas nozzle defines an increasing pressure ratio along a downstream direction from the fuel-oxidizer nozzle, wherein the pressure ratio is relative to a pressure plenum and the detonation chamber.

17. The heat engine of claim 11, wherein the gas nozzle of the RDC system is disposed at an acute angle through the detonation chamber wall.

18. The heat engine of claim 17, wherein the detonation chamber wall defines a longitudinally extended portion within the detonation chamber, wherein the longitudinally extended portion is extended downstream of the gas nozzle to direct the flow of gas at least partially co-directional to the detonation chamber wall.

19. The heat engine of claim 11, wherein the gas nozzle is defined annularly around the combustion centerline.

20. The heat engine of claim 11, wherein the RDC system comprises a plurality of the gas nozzle disposed in an adjacent arrangement around a circumferential direction around the combustion centerline.
